(19) United States
(12) Patent Application Publication
(10) Pub. No.: US 2018/0353901 A1
(43) Pub. Date: Dec. 13, 2018

(54) APPARATUS FOR NITROGEN OXIDES REMOVAL BY OXIDATION WITH OZONE AND SCRUBBING OR ABSORBING THE REACTION PRODUCTS

(71) Applicant: Fluid Technologies (Environmental) Limited, Kingston Upon Thames (GB)

(72) Inventors: Howard Paul Davis, Richmond (GB); David William Missions, Ashford (GB)

(21) Appl. No.: 16/061,854

(22) PCT Filed: Dec. 13, 2016
(86) PCT No.: PCT/GB2016/000216

§ 371 Date: Jun. 13, 2018

(30) Foreign Application Priority Data
Dec. 17, 2015 (GB) GB1523226.7

(51) Int. Cl. B01D 53/56; B01D 47/06; B01D 47/10; B01D 53/75; B01D 53/79; C02F 1/78

(52) U.S. Cl. CPC B01D 53/56; C02F 2201/784; B01D 47/10; B01D 53/75; B01D 53/79; C02F 1/78; B01D 2247/105; B01D 2247/04; B01D 2251/104; B01D 2252/103; B01D 2257/402; B01D 2257/404; B01D 2258/012; B01D 2259/122; B01D 2259/4566; C02F 2201/002; B01D 47/06

(57) ABSTRACT

The present invention provides an apparatus for the treatment of exhaust gas from diesel engine or other combustion type processes, the apparatus comprising liquid and Ozone gas injection means (2) and (3) respectively, for delivering the liquid and Ozone gas into a pressurised exhaust gas stream pipe (1) when the diesel engine or other type internal combustion processes are in use. The liquid and the Ozone gas commingle as the liquid is reduced to a spray of very fine droplets in order to capture sub micron particulate materials before entering a shortened reaction/contacting chamber (4) where the contents undergo a phase change before exiting and entering a gas liquid separator (5) where the liquid droplets are separated from the treated particulate materials, which are subjected to a scrubbing regime in a downstream scrubber (11) before exiting the apparatus through an exit pipe (7). When in use, the apparatus uses the diesel engine or other combustion type process pressure to create high velocities and Reynolds numbers in the shortened reaction/contacting chamber (4) in which NOx is rapidly mixed and reacted with the injected Ozone gas and converted through to N₂O₅ and wherein the sub micron particulate materials, with condensed hydrocarbons, are simultaneously wetted and efficiently captured by the injected and finely sheared liquid droplets.

The present invention is concerned with improvements in or relating to a mist injector apparatus for gas treatment and is particularly concerned, although not exclusively, with the treatment of automotive exhaust gases.

In Applicant's European Patent No. EP1787016B, details of which are included herein by reference, a mist injector apparatus for gas treatment is described in which a fine liquid mist is produced and injected into a gas stream in order to entrap fine particulate material (PM).

The present invention provides an improved mist injector apparatus for injecting Ozone (O₃) and rapidly mixing and reacting it with gaseous NOx pollutants in the gas stream in a highly compact, atomising/reacting or contacting chamber to enable combined PM and NOx capture in a highly compact, downstream, fluidised bed absorber/scrubber, fro example Applicant's Turboscrubber®.

The combination of the improved apparatus overcomes a problem in diesel, boiler, turbine and other process emissions not available without the use of expensive and technically, problematical catalysts.

Emissions of fine particulate hydrocarbons and NOx (Nitric Oxide and Nitrogen Dioxide) from diesel and other internal combustion engines, including those on ships, trains and non-transportation linked power generation as well as boilers and many industrial processes are highly damaging to the environment and cause health problems, especially in big cities globally.

Typical health problems are asthma and a host of respiratory illnesses, which are increasing at an alarming rate in both developing and developed countries. The solid particles, which for health reasons it is most important to remove from exhaust gases are extremely fine particles (particulate matter or PMs), usually in the 0.02-0.3 micron (μm) size range and are often coated with condensed hydrocarbons particularly when emitted simultaneously in the exhaust gases. Diesel engines and other combustion processes have been shown to generate PMs in this very fine range often with a mean diameter lying below 0.5 microns and even between 0.1 and 0.2 micron size.

There have been attempts to combat this ever-increasing problem, especially in the vehicle domain. Early vehicular pollution devices such as catalytic regenerative traps (CRTs), non catalytic particulate traps and Urea or ammonia fed catalysts for NOx reduction (SCRs) have been frequently employed on trucks and heavy goods vehicles. However, retro-fitting such devices, to trains in particular, has become an increasing problem, not least because of the highly limited space and weight constraints when fitted directly on to locomotive engines and the resultant requirement for larger and less fuel efficient propulsion units.

In addition, such devices function with increasing back pressure on the engine as total particulate load in the traps build up over time and the regenerative (SDR) devices require high temperatures, usually >300° C., to ensure good consistent NOx conversion to CO₂ and H₂O and N₂, which is difficult to achieve while, for example, trains are idling in loading yards and at stations. The devices also require cleaning, even regenerative devices need periodic particulate removal, and finally replacing on a fairly frequent basis, usually 1 to 2 years depending upon usage and especially if employed on high mileage trains or constant use generators. These requirements for cleaning and replacing have proven to be time consuming and very expensive.

Accordingly, the present invention obviates or at least mitigates against the disadvantages of the prior arrangements and provides a dual effect apparatus for both injecting liquid and Ozone gas simultaneously from adjacent or close by injection points into a pressurised gas stream containing suspension solids an the form of fine particulates and NOx gases. The apparatus comprises not only a droplet generator including a gas-conveying pressure duct and one or more liquid introducing tubes, which lead into said duct and terminate in one or more spray nozzles, but also one or more Ozone introducing injector nozzles. The duct includes a combined atomising/reacting or contacting chamber in which the sprayed liquid is broken into a mist of very fine liquid droplets that collide with, wet and capture the fine particulate solids with any condensed hydrocarbons (HCs) and in which contacting chamber Ozone gas (O₃) is contacted with and enabled to efficiently react with NOx to rapidly produce the water absorbable compound N₂O₅.

The gas phase reactions between O₃ and NOx:

NO_{(g)}+O3_{(g)}→NO_{2(g)}+O_{2(g)} (1)

2NO_{2(g)}+O_{3(g)}→N₂O_{5(g)}+O_{2(g)} (2)

are relatively fast but at low temperatures, 0° C.-60° C., normally require significant residence times to give high conversion to N₂O₅.

The gas-liquid hydrolysis reaction between N₂O₅ anhydrate and it's acid analogue HNO₃:

N₂O_{5(g)}+H₂O₍₁₎→HNO_{3(aq)} (3)

is virtually instantaneous but can only occur after a much slower intermediate mass transfer or diffusion controlled step to transport the N2O5 through a ‘carrier’ exhaust gas to the surface of any water and once absorption has occurred, in this case millions of fine water droplets that are sprayed in to the contacting chamber and thereafter to the downstream scrubber.

Thus, the present invention overcomes the requirement for long residence times for reaction steps (1) and (2) and takes advantage of the longer interface contact requirement for mass transfer and hydrolysis step (3) by:
(a) using the diesel engine, boiler or process exhaust pressure available to rapidly generate near perfect plug flow conditions and highly turbulent mixing of all the fluids and solids within the reacting or contacting chamber;
(b) separating the water droplets with the captured particulate in an ExVac® seperator; and,
(c) allowing the N₂O_{5(g)} to pass through the droplet separator and afterwards be captured and converted to HNO_{3(aq)} in the high surface area, mass transfer accelerating Turboscrubber® device downstream.

Once mixed in the atomising/reacting or contacting chamber, well, wetted particulates and fine water, or liquid, droplets are then separated from the rapidly generated N₂O_{5(g)} product, by the ExVac® separator, which N₂O_{5(g)} is then readily removable in a compact, downstream fluidised bed Turboscrubber®.

The Turboscrubber® employs eccentric shaped hollow plastic elements to effect a rapid and highly efficient removal of said N₂O₅ vapour from the treated gas.

The ExVac® gas/liquid separator, inverted flow demister, described in EP1787016B1 may thus be usefully inserted between the contacting chamber and the Turboscrubber® to keep the largely PM laden droplets and N₂O₅ vapour apart.

The overall process effected in the improved mist injector apparatus takes advantage of the vastly increased speed of mixing to accelerate gaseous reactions (1) and (2) relative to the slower intermediate mass transfer step required to effect reaction (3) and producing the surprisingly good effect of separating the solid or oily particulate laden water recycled around the contacting chamber, after filtration, from the N₂O₅, which can then absorb and react to form HNO_{3(aq)} in the downstream Turboscrubber®.

The present invention thus provides the extraordinary beneficial effect of enabling extremely rapid conversion, in milliseconds, of PMs/HCs and NOx, via highly turbulent interaction with the same small contactor, into removable form for easy separation downstream of the atomising/reacting chamber in two steps, if required, which enables far cleaner and safer capture of N₂O_{5(g)} as a potentially recoverable Nitric Acid product.

Thus, the present invention is particularly well suited to efficiently capturing very fine particulate emissions, HCs and NOx from diesel and internal combustion engines and other processes where the necessary engine pressure is available to facilitate the pressure drops required in the reacting chamber.

The reacting chamber thus forms part of the invention to be marketed as ENSPIRIT®, And also incorporating the compact Turboscrubber® for cleaning up diesel, boiler and process exhaust gases.

The available pressure in diesel engines or generated by compressors and fans is effectively used in the reactor's design, which includes shape and form selection, including any inner baffling, diameter and length, to create the required conditions of high gas velocity and Reynolds numbers as well as residence time which are critical for high conversion of NOx and PMs to wet matter perfect for downstream capture.

Large diesel locomotives vary in power from about 2,000 BHP to 6,000 BHP. The popular 4,000 BHP diesel freight locomotives engines' exhaust gas flow rates, for example, typically vary between about 4,000 m³/hr and 20,000 m³/hr depending on weight hauled, speed and rail inclines. During low speed driving and idling the exhaust gas flow rates tend to be relatively low although PM and NOx emissions are nevertheless high.

During periods of high engine load, such as accelerating, travelling up hill and at high speeds, the gas flow rates increase substantially as do PM and NOx emissions.

The emission abatement performance of the present invention has the advantageous characteristic of improving as the gas flow rate increases through the mist injector for both PM and NOx removal.

Currently, the USA and Canada are moving towards Tier 4 Emission limits for PMs and NOx while the European Union is bringing in Stage IIIB Emissions limits for diesel locomotives. These new and more stringent limits being introduced from 2015 onwards will respectively require reductions of up to 76% NOx and 70% PMs in North America and 45% NOx and 35% PMs in Europe with respect to the previous legislative requirements.

During trials on an Enspirit® prototype, operated using VW and Alpha Romeo diesel motor car engines specially adapted to simulate train locomotive ‘notches’, overall emissions reductions of 90-96% were achieved for NOx and around 60% for PMs with average particle size of about 0.14 microns. Both efficiencies are readily improvable by design enhancement.

To achieve such surprisingly good, simultaneous results, the gas stream at the point of liquid injection should be at elevated pressure, preferably in the range 2.0 to 40.0 kPaG.

Gas streams from diesel train exhaust systems automatically provide such pressures without the need for compression, which is required for other processes. For industrial processes and boiler plant it is desirable to optimise the gas pressure drop through the system, most preferably to be in the range 2.0 to 10 kPaG.

For diesel trains the pressure drop will vary through the stated range as the gas flow increases and decreases during diesel train maneuvers with typical idling pressure drops being around 2-4 kPa and highest notch (8) pressure drops around 30-35 kPa. An important advantage of the present invention is that the pressure drop range does not deteriorate or increase over time due to blockage; thus relieving strain on the diesel or other engine or process due to excessive or increasing back pressure.

Thus by designing or selecting a atomising/reacting chamber of selected diameter, shape and length, which may include internal baffles, to operate in these pressure ranges, it is possible to obtain the following normally unachievable results within such extremely short residence times from only a few milliseconds up to 200 milliseconds, by selecting chamber length to diameter ratios L/d between 1.0 and 20.0 and a preferred range of 2.0 to 8.0 across the full design and operating spectrum.

The normally unachievable results are:
1) overall removal of the NOx by conversion to N₂O₅ in the reaction chamber followed by rapid absorption in a fluidised bed Turboscrubber® to in excess of 90%;
2) simultaneous wetting by inertial impaction of sub half micron particulate in the reacting chamber followed by wetted PM removal in a fluidised bed Turboscrubber® to in excess of 60%; and,
3) steady appliance of back pressure by the reacting chamber within the generated pressure range of diesel engines to minimise over exertion and damage to the engine and to maintain good efficiency.

It is important to maintain liquid to gas ratios within the range 0.15 to 2.0 litres/m³, i.e. water to gas volume ratio, with a preferred range of 0.2 to 1.2 litres/m³, to ensure that both the optimum large number of very fine droplets, typically in the range 10 to 300 microns diameter depending upon nozzle arrangement and gas-liquidshear, is generated and simultaneously to maintain an optimum system pressure loss.

There are many options for the shape of the atomising/reacting chamber at the liquid injection point. It can be a pipe or plenum chamber and can be for example circular, cylindrical, ellipsoidal, square, rectangular, curved, rounded, bent or tapered, or in a full, extended or partial vena contracta, i.e. reducing then opening. The shape and any internal constrictions may, however, be such that gas passing through the atomising/reacting chamber is reduced in pressure at the point(s) of liquid and Ozone injection, for example by including orifice(s), plate(s) or other pressure loss generating constrictions, such that the liquid atomisation and rapid Ozone delivery and distribution is enhanced under reduced pressure.

In a preferred apparatus provided by the present invention, the reduced pressure is achieved by passing the gas stream through an elongated throat or chamber. The increased velocity and reduction in pressure of the gas stream as it passes through a long venturi type throat are highly effective in creating the required conditions for droplet shearing and producing wetting and downstream capture of the PMs in the ExVac® droplet separator as well as the perfect condition required to rapidly mix the O₃ with the NOx vapours for capture as N2O5 in the downstream Turboscrubber®.

To generate enough N₂O₅ for high efficiency removal, the O₃ to NOx ratio, in molar terms, must be at the very least 1.0:1.2 and is preferably >1.5:1.0 because the reaction rate depends upon the partial pressures of both NOx gases and the O₃ being a second order reaction with both NOx species, i.e. NO+O₃ [symbol] NO₂+O₂, followed by and in parallel with 2NO₂+O₃ [symbol] N₂O₅+O₂, the latter reaction going through an intermediate 2^{nd} order NO₃ rate limiting step, and because insufficient O₃ injection leads to a sub-stoichiometric conversion restriction of N₂O₅ product formation irrespective of the quality of the mixing.

In order to ensure good, rapid mixing in the reaction chamber, it is crucially important to operate within both the right carrier gas velocity, Ug in m/s, and throat length, L in metres ranges. The term √(Ug×L) like the NOx and O₃ partial pressures has been found to be strongly related to the mixing efficiency of the overall NOx (NO and NO₂) and O₃ reactions and it should, therefore, be chosen such that its range is between 0.2 and 20.0 with a preferred optimum range of 1.5 to 15.0.

For example, a short 100 mm length throat with a gas velocity of 30 m/s will have a (U×L) value of 1.732 whereas a 500 mm length throat with a gas velocity of 200 m/s will have a √(U×L) value of 10.0.

If compared to a gas scrubbing arrangement with a typical gas velocity of 2 m/s and a contacting zone height of 5 m into which Ozone is injected at the inlet, the value of √(U×L) cab be seen to be 3.16; however, the residence time of the gas would be 2,500 milliseconds being way beyond the maximum residence time requirement of 200 milliseconds in the Enspirit® reacting chamber. This shows that by operating at higher gas velocities and Reynolds numbers, the scale of the reacting chamber and the overall system is massively reduced.

The simple application of the √(Ug×L) formula thus leads directly to the selection of a diameter to generate the necessary velocities for a given selected throat length across the range of flows to be encountered in each diesel, boiler plant or other process applications.

Values of √(Ug×L) above 15.0 may lead to excessive and unnecessary pressure drop and back pressure whereas values below 1.5 may lead to insufficient mixing in addition to insufficient contacting of fine water droplets and PMs.

In many applications, and especially in vehicular exhaust cases, it is desirable to reduce losses of injected liquid, water being the preferred liquid, and/or to re-circulate the liquid. Liquid evaporation and mist losses are reduced by such factors as low liquid to gas ratios, low residence time of the droplets and low temperatures.

Liquid re-circulation can be achieved by one or more pumps that draw liquid from the fine droplet separator around a purpose built tank system. In a vehicle system the power to drive the pump(s) can be taken from the vehicle's electrical circuit.

The liquid re-circulation system preferably includes one or more filters, preferably of readily replaceable modules, to remove the particulates from the liquid before it is reused. In bulk, the collected particulates are usually a sooty mass with hydrocarbon condensate traces, which would otherwise tend to build up and block the system.

The evaporative cooling effect of the very fine droplets maintains a reduced temperature in the re-circulated liquid. In the case of vehicle systems and water injection, the evaporative cooling effect prevents the temperature of re-circulating water exceeding 45° C. This is beneficial in vehicle systems in that the volumes of top-up water required to achieve the particulate removal are similar to and typically less than the engine fuel consumption rates such that the tank size can be of similar size to the fuel tank. Thus refilling the water tank can conveniently take place at infrequent intervals, for example when refuelling the vehicle.

In one embodiment provided by the present invention, the liquid supply is provided or boosted by a rainwater collection device and storage tank therefore. This reduces the frequency of water top-up, which is especially helpful in vehicle systems.

A further benefit when using a device according to the present invention in a motorised vehicle is that, unlike a blocked catalyst, it does not significantly effect the operation of the vehicle engine. If the device fails for any reason, for example running out of liquid to be injected, the engine continues to operate, albeit with the release of more pollutant particulates that would otherwise have been removed since the downstream Turboscrubber® is principally designed to remove N₂O₅ but not designed to remove much of the very fine PMs.

In a still further preferred embodiment provided by the present invention, a Turboscrubber® unit for absorbing and removing residual gases and vapours, for example N₂O₅, soluble hydrocarbons and wetted PMs, is located immediately downstream of the contacting device.

The present invention also provides a pollution control device that can efficiently clean a gas stream by removing particulates, NOx and condensed hydrocarbons (on particulates) without the need for expensive catalysts using costly and rare precious metals. The pollution control device is readily constructed as a simple modular system, which is low maintenance, has a long life, and for diesel train applications, can be housed in a standard container or placed on a flat wagon behind a locomotive, and which pollution control device works consistently at all time without blockage.

Thus, the present invention provides an improved mist injector apparatus for gas treatment in accordance with the Claims appended hereto.

There now follows, by way of example, a detailed description of the present invention, which description is to be read with reference to the accompanying drawings in which:

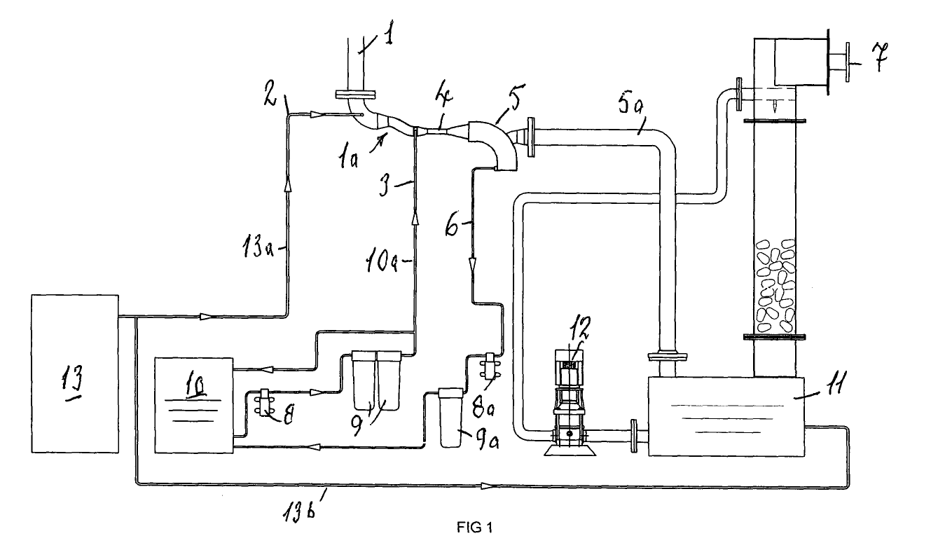

FIG. 1 illustrates a block diagram of the present invention;

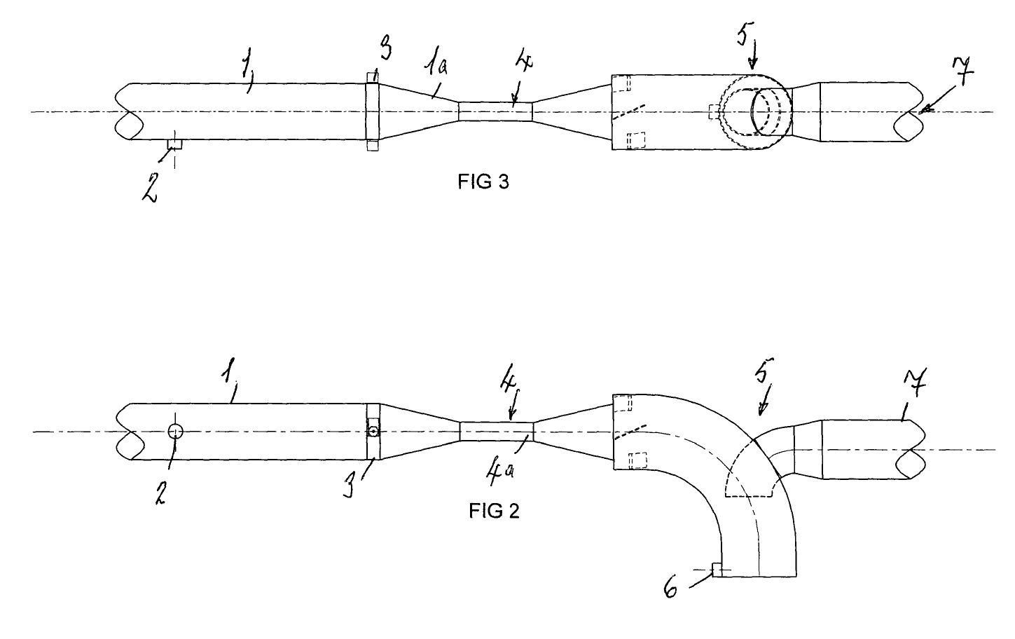

FIG. 2 is a side elevation of a contacting chamber of the present invention; and,

FIG. 3 is a plan elevation of the contacting chamber of FIG. 2.

The present invention, see FIG. 1, provides a mist injector apparatus for the treatment of exhaust gas from a diesel or internal combustion engine and generally comprises an exhaust pipe 1 for conveying the exhaust gas from the engine, not shown, a duct la leading to a combined atomising/reacting or contacting chamber 4, hereinafter referred to as the contacting chamber 4, a gas/liquid separator 5, a water storage tank 10 and a scrubber 11 that leads to an outlet 7 for the treated gas.

The present invention also comprises an Ozone generator 13 connected to the exhaust pipe 1 by a feed pipe 13a and by a pipe 13b to the scrubber 11, see FIG. 1. The pipe 13a terminates in an Ozone injecting tube, not shown, located within the exhaust pipe 1.

The water storage tank 10 is connected by a pipe 10a to the exhaust pipe 1 at a point downstream from the Ozone injecting tube and upstream of the contacting chamber 4 by a pipe 10a, which terminates in a water injecting tube, not shown, located within the exhaust pipe 1. The pipe 10a is provided with a pump 8 and filters 9 for the delivery of clean water to the water injecting tube within the exhaust pipe 1 as aforesaid.

The contacting chamber 4 is provided by an elongate tubular member 4a having dimensions of length to diameter ratio L/d of between 1.0 and 20.0 and a preferred range of 2.0 to 8.0 across the full design range and operating spectrum. The tubular member 4a of the contacting chamber 4 is connected at a downstream end thereof to the gas/liquid separator 5, see especially FIGS. 2 and 3.

The gas/liquid separator 5, which is generally as described and shown in Applicants European Patent No. EP1787016B, is connected downstream to the scrubber 11 by a pipe 5a, see FIG. 1. The gas/liquid separator 5 is also connected by a return pipe 6 for spent water that is fed back to the water storage tank 10 by a pump 8a and through filters 9a provided along the return pipe 6 between the gas/liquid separator 5 and the water storage tank 10, see FIG. 1.

When the mist injector apparatus of the present invention is in use for the treatment of exhaust gas emitted from a diesel or an internal combustion engine, Ozone is delivered from the Ozone generator 13 via the pipe 13a to be injected into the exhaust pipe 1 through one or more Ozone injection nozzles, not shown, located within the exhaust pipe 1. Concomitantly therewith, liquid, i.e. water is fed by the pump 8 from the water storage tank 10 through the pipe 10a and the filters 9 into the exhaust pipe 1 through one or more liquid injection nozzles, not shown, located within the exhaust pipe 1 downstream of the Ozone injection nozzles.

The liquid injection nozzles provide a fine spray of very small water droplets that co-mingles with the Ozone from the Ozone injecting nozzles to capture small particulate materials that are carried by the exhaust gas, the size of which particulate materials are usually in the 0.02-0.3 micron (um) size range, which particulate materials are often coated with condensed hydrocarbons that are emitted simultaneously along with the exhaust gas.

Thus the exhaust gas co-mingled with the Ozone and the very fine water droplets enter the compacting chamber 4 wherein, because of the length to diameter size ratio of the chamber, the Ozone gas reacts with NOx to rapidly produce water absorbable N₂O₅.

The treated particulate materials pass from a downstream end of the compacting chamber 4 and into the gas/liquid separator 5 where the water is drained off at a lower portion of the separator and into the pipe 6 to be fed by the pump 8a through the filter 9a back to the water storage tank 10 to be re-circulated through the system.

From the gas/liquid separator 5, the rapidly generated N₂O_{5(g)} is conveyed through the pipe 5a to the Turboscrubber® where the N₂O_{5(g)} is removed leaving the treated exhaust gas to exit to atmosphere through the outlet pipe 7.

The pumps 8 and 8a are electrically driven and powered by the vehicle electric power if mounted on a train or ship.

The filters 9 and 9a are easily cleaned or readily replaced every 3 to 6 months if necessary. Likewise, the water storage tank 10 is equipped with suitable connections for ease of filling, draining and cleaning.

Modifications to the mist injector apparatus is envisaged to be within the scope of the Claims appended hereto.

For example:
1. The subject apparatus is effective in separating PM/HC from NOx, via N₂O₅ product removal to the benefit of allowing a cleaner formation of recoverable HNO₃ product.
2. The apparatus may also be used for either NOx or PM/HC removal on their own, from industrial emissions, in cases where only one pollutant is present, for example, low NOx boilers still generate PMs and HCs.
3. The liquid used in the subject apparatus may also include oils and aqueous reagents.

1. An apparatus for injecting liquid into a pressurised gas stream containing suspended solids in the form of fine particles as well as NOx vapours or gases, which apparatus comprises a gas-liquid-vapour contacting pressure duct (1) including a droplet generator (1a) comprising liquid introducing means (2), which lead into said duct (1) and terminate in one or more spray nozzles for producing a very fine spray of liquid droplets, the apparatus also comprising a droplet separator (5) where the liquid and the particulate laden exhaust gas are separated, the apparatus also comprising a scrubber/absorber (11) wherein the reacted gas product N₂O₅ is liberated from the surrounding carrier gas, characterised in that the apparatus further comprises means (3) for injecting Ozone gas into the pressure duct (1) and the pressurised gas stream contained therein when the apparatus is in use, the apparatus further comprising a combined atomising/reacting contacting chamber (4) in which injected liquid in very fine droplet form commingles with the Ozone gas as the liquid droplets collide with and capture the fine particulate solids suspended in the pressurised gas stream, which fine particles are removed in the droplet separator and the commingled Ozone gas passes through the droplet separator (5) whereafter the N₂O₅ reaction product enters the scrubber (11) whereat, when the apparatus is in use, the pressurised gas is freed of any N₂O₅ and residual droplets before passing to atmosphere through an outlet (7).

2. An apparatus as claimed in claim 1, characterised in that the liquid spray is directed co-currently with the Ozone into the pressurised gas stream.

3. An apparatus as claimed in claim 1, characterised in that the droplets in mist form have a diameter in the range of 10 to 300μ by maintaining the liquid to gas ratio between 0.15 and 2.0 litre/m3.

4. An apparatus as claimed in claim 3, characterised in that the liquid to gas ratio is preferably maintained between 0.2 and 1.2 litres/m3.

5. An apparatus according to claim 1, characterised in that the liquid is one or more of town water, rainwater, river water, seawater, domestic or industrial wastewater.

6. An apparatus according to claim 1, characterised in that the chamber (1) at the liquid introducing means (2) is circular, ellipsoidal, square or rectangular.

7. An apparatus according to claim 1, characterised in that the duct (1) incorporating the chamber (1a) is straight, curved, rounded, bent, tapered or in a full or partial vena contracta, i.e. reducing then opening.

8. An apparatus according to claim 7, characterised in that the chamber (1a) includes a venturi section, one or more orifice plates or other pressure loss generating restriction.

9. An apparatus according to claim 1, characterised in that the value of the square root of the product of the chamber (4) gas velocity U_{g} and its length L (Ug×L)̂^{0.5} lies between 0.2 and 20.0 and preferably lies between 1.5 and 15.0.

10. An apparatus according to claim 1, characterised in that the molar ratio of the injected Ozone as compared to the total NOx (NO+NO₂) gas is at least 1.2:1 and is preferably greater that 1.5:1.

11. An apparatus according to claim 1, characterised in that the residence time of the gas does not exceed 200 milliseconds and where the L/d, i.e length to diameter, ratio of the chamber (4) lies between 1.0 and 20.0 and more preferably between 2.0 and 8.0.

12. An apparatus according to claim 1, characterised in that a re-circulating system including one or more pumps (8, 8a) are provided to re-circulate the liquid from the separator (5) to the liquid injecting means (2).

13. An apparatus according to claim 12, characterised in that the re-circulating system includes one or more filters (9, 9a) for the removal of particulates from the liquid before it returns to the water storage tank (10) for [symbol]
